(19) United States
(12) Patent Application Publication
(10) Pub. No.: US 2009/0248745 A1
(43) Pub. Date: Oct. 1, 2009

(54) METADATA MANAGEMENT APPARATUS

(75) Inventors: Naoki Kuwahara, Tokyo (JP); Tetsuji Haga, Tokyo (JP); Koichi Takeuchi, Tokyo (JP); Koichi Sasakawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/177,356

(22) Filed: Jul. 22, 2008

(30) Foreign Application Priority Data
Mar. 28, 2008 (JP) 2008-086747

(51) Int. Cl. G06F 17/30

(52) U.S. Cl. 707/104.1; 707/E17.02

(57) ABSTRACT

A link table (28) showing a link relation between video data which are time reference data and log data which are number reference data is disposed. When the video data are deleted from a video recording ring buffer (23) or when the log data are deleted from a log recording ring buffer (26), a link data management unit (27) instructs either a number reference data recording and deleting unit (25) or a time reference data recording and deleting unit (22) to also delete the data which are the link destination of the deleted data with reference to the link table (28). Simultaneously, the link data management unit (27) deletes the link relation from the link table (28).

### BACKGROUND OF THE INVENTION

1. Field of the Invention

The present invention relates to a metadata management apparatus for use in, for example, a monitor video image recorder used for monitoring which records a monitor video image and has a searching function.

2. Description of Related Art

A monitor video image recorder records an input video image from a monitoring camera into a recording medium, such as a hard disk. Because this apparatus is indented for monitoring, it is required to have a function of continuing recording the input video image without having any rest from the recording (referred to as an endless recording function from here on). In this case, because the capacity of the recording medium is limited, after recording the input video image until the recording medium is full, the monitor video image recorder continues recording the input video image while overwriting and deleting video data already recorded into the recording medium with the input video image. In general, because if no abnormal conditions occur, the monitor video image is not watched again, the conventional monitor video image recorder overwrites and deletes video data already recorded into the recording medium with the input video image in the chronological order in which the video data were recorded into the recording medium.

Conventionally, there has been provided an image recording apparatus which performs endless recording of a video image, as disclosed by, for example, patent reference 1. In such a conventional image recording apparatus, a continuous recording control unit manages a recording area on a hard disk which is divided into some blocks, and manages a chain of pointers indicating blocks in which video data are written, respectively, in such a way that the blocks are running in the chronological order in which the video data were recorded in the blocks, so as to implement the endless recording. The above patent reference also describes an event recording process of recording a video image in synchronization with an event signal. With this event recording process, video images at times before and after an event signal occurs are recorded, as event video images, into a recording medium while the recording of them is distinguished from the endless video recording. Because blocks in which the event video images are recorded are excluded from the block pointer chain which is used for the endless video recording, major features of the event recording are that the event video images are not overwritten and deleted with the endless recording and only an event video image can be searched for because the event video images are managed independently. Particularly, the fact that the event video images are managed independently is the most striking feature of the event recording. The reason why the most striking feature of the event recording is that the event video images are managed independently is because, in recent years, recording media have increased in capacity and it is difficult for users to watch all the video images currently recorded in the recoding medium again, and therefore the searching of a desired video image with reference to a bookmark, such as an event signal, offers an advantage of being able to greatly reduce the time required to search for the desired video image.

There have been provided many conventional methods of analyzing a video image and recording, as metadata about the video image, feature data simultaneously in order to improve the accuracy of searching (for example, refer to patent reference 2). According to these methods, an input video image is analyzed and metadata are created, and searching with a keyword is carried out by using the created metadata, thereby remarkably improving the accuracy of searching for video data.

However, such a conventional recording method is applied only to video data which become unchanged after the recording of the video data is completed temporarily, but the technology cannot be applied to endless recording intended for monitoring, just as it is. This is because, in the case of endless recording, it is necessary to delete video data and metadata from the viewpoint of the storage capacity, and it is further necessary to delete both of them synchronously in order to prevent any contradiction from arising when making a search.

As such a method of deleting both video data and metadata synchronously, there has been provided, for example, an image searching apparatus as shown in patent reference 3. While this image searching apparatus records image data into an image storage device, the image searching apparatus holds feature quantities of images as metadata in order to improve the efficiency of image searching. In this case, the image searching apparatus acquires a list of images currently recorded in the image storage device at regular intervals, newly creates image feature quantity data about an image which has been added newly, adds them to a feature quantity list, and deletes an image currently recorded and metadata about the image (feature quantity data) synchronously by deleting the feature quantity data about the image deleted from the feature quantity list.

Thus, for the conventional image monitoring system, a method of recording metadata while establishing a link with a corresponding video image has begun to come into proliferation in order to improve the accuracy of searching of a video image. It is further convenient to record not only metadata but also a log acquired from other equipment, measurement data from a sensor, and so on into a video recorder, and to enable a “link search” process of establishing a link between them and video data, and making a search for each other.
[Patent reference 1] JP,10-145734,A
[Patent reference 2] JP,2006-303745,A
[Patent reference 3] JP,2006-185320,A

However, logs and measurement data in an entrance and exit control system, a facilities management system, etc. are managed with reference to number, and therefore a data control method of controlling the data differs from that which a video recorder operating with reference to time uses. More specifically, while a video recorder records video data with reference to time, e.g., one week of past video data, each of log data and measurement data are held as a history based on its number, e.g., a history of 1,000 most recent entries. Because a log is created by an event-driven process and, fundamentally, is not related with any video data recording time, there is no guarantee that a history of 1,000 most recent entries corresponds to one week. Thus, because there is a difference in a standard about recording times between video data, and log data and measurement data, making a link search on the basis of on one of them ends in failure in many cases because the other data are already lost. In addition, in a case in which creation of log data triggers a system to perform event video recording, like in the case of the image recording apparatus disclosed in above-mentioned patent reference 1, if no synchronization is established between the log data and the video data, an overwrite prohibition process which is caused by the event video recording remains even though the log data have been deleted, and therefore there arises a problem that the video data which have become old also remain indefinitely.

In addition, in the image searching apparatus as disclosed in above-mentioned patent reference 3, in a case in which there is a continuous one-to-one correspondence between image data and feature quantity data about the image data, any search does not end in failure because a link can be correctly established between the image data and the feature quantity data. However, because the number of feature quantity data which can be held has an upper limit, in a case in which the amount of image data increases greatly, and, for example, the number of feature quantity data which are generated from the image data exceeds its upper limit number which can be held, the one-to-one correspondence between the feature quantity data and the image data cannot be maintained and following the link between them may end in failure. Furthermore, the image data may have remained in a state in which they are prohibited from being overwritten.

It is thus difficult to, by using any of the conventional methods, construct an apparatus or a system which collectively records data which are managed with reference to time and data which are managed with reference to number, and which establishes a link between them so as to make it possible to make a search for each other.

### SUMMARY OF THE INVENTION

The present invention is made in order to solve the above-mentioned problems, and it is therefore an object of the present invention to provide a metadata management apparatus which can record data into even a recorder used for monitoring, which performs endless recording, without producing any mismatching in a link and without leaving useless event-triggered recorded video images in the recorder.

In accordance with the present invention, there is provided a metadata management apparatus including a time reference data recording and deleting unit for receiving time reference data which are managed with respect to time and recording the time reference data into a ring buffer for time reference data, and for deleting the time reference data from the ring buffer for time reference data; a number reference data recording and deleting unit for receiving number reference data which are managed with reference to number and recording the number reference data into a ring buffer for number reference data, and for deleting the number reference data from the ring buffer for number reference data; a link table for storing a link relation between the time reference data and the number reference data; and a link data management unit for updating the link table according to a recording state of the ring buffer for time reference data and a recording state of the ring buffer for number reference data, in which, when the number reference data are recorded into the ring buffer for number reference data, the link data management unit adds the link relation between the number reference data and the time reference data to the link table, and, when the time reference data are deleted from the ring buffer for time reference data or when the number reference data are deleted from the ring buffer for number reference data, instructs either the time reference data recording and deleting unit or the number reference data recording and deleting unit to also delete the data which are a link destination of the data which are deleted with reference to the link table, and then deletes the link relation from the link table.

As previously mentioned, the metadata management apparatus in accordance with the present invention includes the link table showing a link relation between time reference data and number reference data, and, when the time reference data are deleted from the ring buffer for time reference data or when the number reference data are deleted from the ring buffer for number reference data, also deletes the data which are the link destination of the deleted data with reference to the link table and further deletes the link relation from the link table. Therefore, the metadata management apparatus can record data into even a recorder used for monitoring, which performs endless recording, without producing any mismatching in a link and without leaving useless event-triggered video images in the recorder.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing an image monitoring system for implementing a metadata management apparatus in accordance with Embodiment 1 of the present invention;

FIG. 2 is a block diagram showing the metadata management apparatus in accordance with Embodiment 1 of the present invention;

FIG. 3 is an explanatory drawing showing the structure of a searching function which uses the metadata management apparatus in accordance with Embodiment 1 of the present invention;

FIG. 4 is a block diagram showing a metadata management apparatus in accordance with Embodiment 2 of the present invention; and

FIG. 5 is an explanatory drawing in a case in which the chronological order in which metadata appear is reverse to that in which the metadata are recorded in the metadata management apparatus in accordance with Embodiment 2 of the present invention.

### DETAILED DESCRIPTION OF THE PREFERRED EMBODIMENTS

The preferred embodiments of the present invention will be now described with reference to the accompanying drawings. In the following description of the preferred embodiments, like reference numerals refer to like elements in the various views.

### Embodiment 1

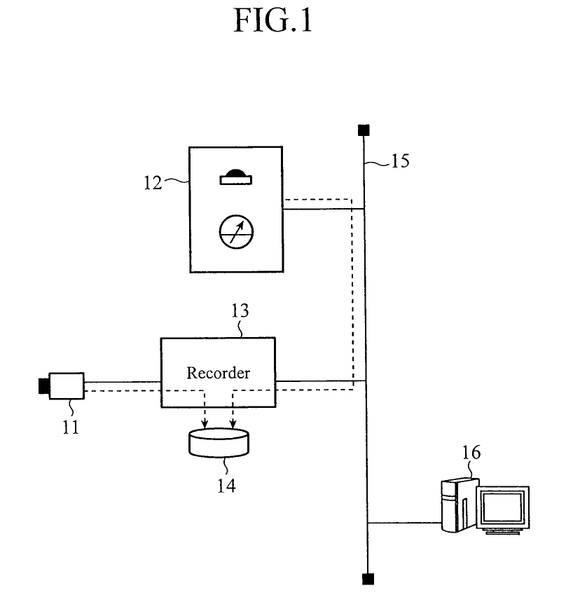

FIG. 1 is a block diagram of an image monitoring system for implementing a metadata management apparatus in accordance with Embodiment 1 of the present invention. The image monitoring system is provided with a camera 11, sensors (pieces of measurement equipment) 12, a recorder 13, a recording medium 14, a network 15, and a playback terminal 16. The camera 11 is an image pickup unit which acquires an image which is a target to be monitored. The sensors (pieces of measurement equipment) 12 denote various sensors or various pieces of measurement equipment. The recorder 13 captures video data from the camera 11 via an analog cable or a network cable so as to perform endless recording of the video data into the recording medium 14. The recorder 13 also captures log data from the sensors (the pieces of measurement equipment) 12 via the network 15 and records them thereinto so as to perform endless recording of the log data into the recording medium 14. The playback terminal 16 can connect with the recorder 13 via the network 15 and can search for video data and log data by using, as a search key, either a time or a value of log data.

Each of video data and log data has link information, and one of them can be acquired from the other one of them. For example, when a user specifies a time first to acquire video data, and has discovered a scene which the user likes after playing back the video for a while, the user can search for log data about the scene (a corresponding time) to acquire them. In contrast, when the user has found log data which the user likes after searching through the log data stored in the recording medium, the user can make the playback terminal play back a video image associated with the log data.

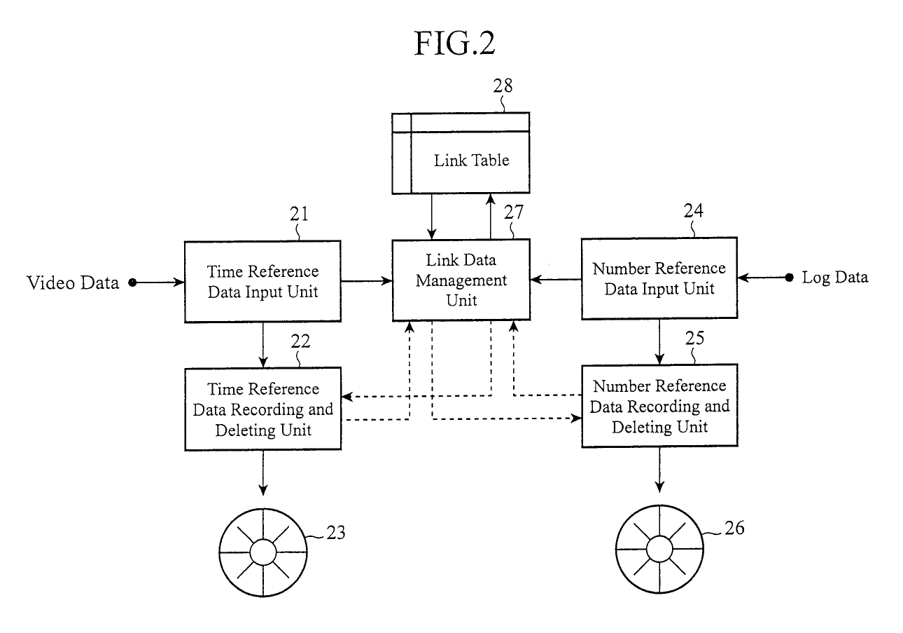

Next, the function configuration of the recorder 13 will be explained. FIG. 2 is a diagram showing the function configuration of the recorder, and shows the metadata management apparatus. In FIG. 2, in order to make the explanation plain, the illustration of functions which are related to searching will be omitted hereafter. The functions which are related to searching are shown in another diagram and will be mentioned below. As shown in FIG. 2, the metadata management apparatus is provided with a time reference data input unit 21, a time reference data recording and deleting unit 22, a video recording ring buffer 23, a number reference data input unit 24, a number reference data recording and deleting unit 25, a log recording ring buffer 26, a link data management unit 27, and a link table 28.

The time reference data input unit 21 is an interface which receives video data which are time reference data which are managed with reference to time from the camera 11. The time reference data recording and deleting unit 22 is a functional unit which records the video data inputted to the time reference data input unit 21 into the video recording ring buffer 23, and which deletes video data which are currently recorded in the video recording ring buffer 23. The video recording ring buffer 23 is a ring buffer intended for time reference data, for storing time reference data. The number reference data input unit 24 is an interface which receives log data which are number reference data which are generated by the sensors (the pieces of measurement equipment) 12 and which are managed with reference to number. The number reference data recording and deleting unit 25 is a functional unit which records the log data inputted to the number reference data input unit 24 into the number reference data recording and deleting unit 25 and which deletes log data which are currently recorded in the number reference data recording and deleting unit 25. The log recording ring buffer 26 is a ring buffer intended for number reference data, for recording log data which are number reference data.

The link data management unit 27 is a functional unit which, on the basis of both the time reference data from the time reference data input unit 21, and the number reference data from the number reference data input unit 24, registers a link relation between the time reference data and the number reference data into the link table 28, and which updates the link table 28 on the basis of both deletion of video data from the video recording ring buffer 23 by the time reference data recording and deleting unit 22, and deletion of log data from the log recording ring buffer 26 by the number reference data recording and deleting unit 25. The link table 28 shows a correspondence between the video data which are currently recorded in the video recording ring buffer 23 and the log data which are currently recorded in the log recording ring buffer 26.

The above-mentioned time reference data recording and deleting unit 22, the above-mentioned number reference data recording and deleting unit 25, and the above-mentioned link data management unit 27 are implemented via either pieces of hardware intended for them or pieces of software which correspond to their respective functions and pieces of hardware which execute the pieces of software, such as a CPU and a memory.

Next, the operation of the recorder 13 which is constructed in this way will be explained. Video data from the camera 11 for monitoring are inputted to the time reference data input unit 21 in time sequence. The time reference data input unit 21 attaches time information (a time stamp) to the inputted video data, and informs this time information to the link data management unit 27. The time reference data input unit 21 also delivers the video data to the time reference data recording and deleting unit 22. The time reference data recording and deleting unit 22 additionally writes the video data received from the time reference data input unit 21 into the video recording ring buffer 23. When the video recording ring buffer 23 is full, the time reference data recording and deleting unit 22 deletes and overwrites the video data having the oldest time stored in the buffer with new video data.

On the other hand, when log data are created in the sensors (the pieces of measurement equipment) 12, the log data are inputted to the number reference data input unit 24 via the network 15 and are then delivered from the number reference data input unit 24 to both the link data management unit 27 and the number reference data recording and deleting unit 25. The link data management unit 27 establishes a correspondence between the log data and the video data on the basis of the time information included in the log data, and additionally writes the correspondence between the log data and the video data into the link table 28. In this case, the time information included in the log data can be the occurrence time of the log, a time section for a process described in the log, a start time or an end time of the time section, an intermediate time within the time section, or the like. The number reference data recording and deleting unit 25 additionally writes the received log data into the log recording ring buffer 26. The log recording ring buffer 26 can record a predetermined number of logs, and, when this buffer is full, the number reference data recording and deleting unit 25 deletes the log having the oldest time information and overwrites the buffer area in which this log was recorded with a new log.

Next, processing in a case which the video data are overwritten in the video recording ring buffer 23 and processing in a case which the log data are overwritten in the log recording ring buffer 26 will be explained. When the number of records of the log data exceeds the above-mentioned predetermined number of records which can be recorded in the log recording ring buffer 26, the number reference data recording and deleting unit 25 deletes the log data having the oldest time information from the log data which are currently recorded in the log recording ring buffer 26. Furthermore, the number reference data recording and deleting unit 25 notifies the link data management unit 27 that the log data have been deleted. The link data management unit 27 refers to the link table 28 so as to check to see whether the deleted log data have a link. When the deleted log data have no link, the link data management unit 27 does not perform any particular process. In contrast, when the deleted log data have a link, the link data management unit 27 instructs the time reference data recording and deleting unit 22 to delete the video data in the time section which is the link destination and deletes the statement about the correspondence between the log data and the video data from the link table 28. The time reference data recording and deleting unit 22 then deletes the video data in the specified time section. It cannot be overemphasized that in the process at the time when the above-mentioned overwriting is performed, data which have to be deleted can be detected promptly if the log recording ring buffer 26 is sorted in such a way that the log data are aligned in the chronological order of the above-mentioned time information included in the log data, and, similarly, if the link table 28 is sorted, whether the deleted log data have a link can be checked to see promptly.

By the way, when recording video data, by assuming log data to be an event signal, the time reference data recording and deleting unit 22 can record, as an event video image (which is distinguished from a video image recorded through the endless video recording), the video data which are linked with the log data, as shown in, for example, patent reference 1. In this case, because an area of the recording medium in which the video data which are linked to the log data are recorded is not used for the endless video recording, the time reference data recording and deleting unit 22 reuses the area as an area intended for the endless video recording after deleting the video data in the above-mentioned overwriting process.

On the other hand, the processing in the case in which the video data are overwritten is the same as that in the case in which the log data are overwritten. When deleting video data, the time reference data recording and deleting unit 22 notifies the link data management unit 27 that the time reference data recording and deleting unit has deleted the video data. The link data management unit 27 refers to the link table 28, and, when the deleted video data have a link, deletes the log data which is the link destination. Once the processing of overwriting the video data is started, a notification that overwriting has been performed is provided to the link data management unit 27 with a remarkable high frequency. Therefore, there is provided a method of notifying that overwriting has been performed every time when a certain volume of video data is deleted without notifying that overwriting has been performed every time when video data are deleted. Furthermore, it is desirable that the link table 28 is sorted according to the above-mentioned time information included in the log data.

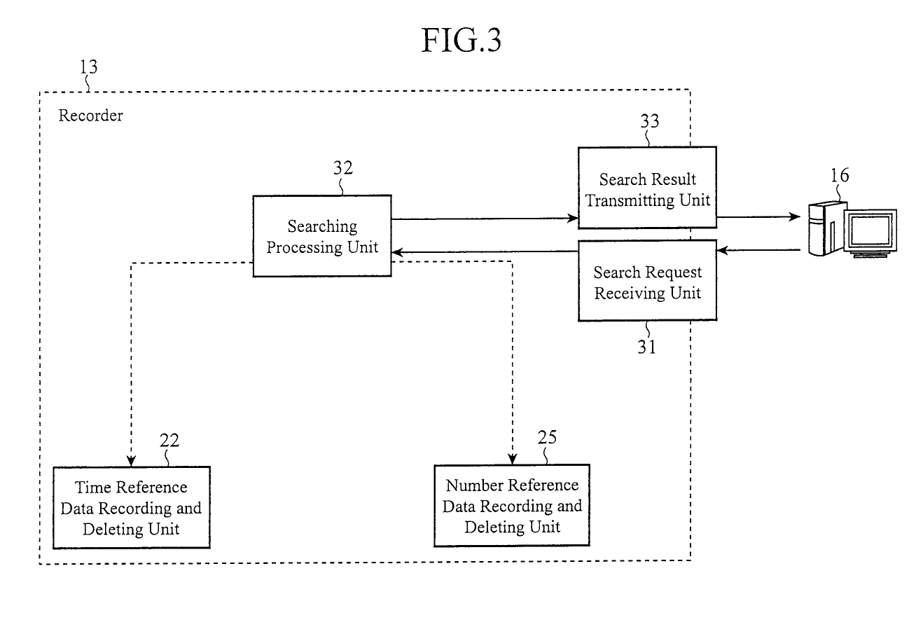

Finally, searching processing will be explained with reference to FIG. 3. FIG. 3 shows the configuration of the searching function of the recorder 13 shown in FIG. 1, and the recorder 13 is provided with a search request receiving unit 31, a search processing unit 32, and a search result transmitting unit 33. The search request receiving unit 31 receives a search request message from outside the recorder, and delivers this search request message to the search processing unit 32. The search processing unit 32 is a functional unit which makes an inquiry to either the time reference data recording and deleting unit 22 or the number reference data recording and deleting unit 25 on the basis of the search request message from the search request receiving unit 31, and sends out, as a search result, the result of the inquiry to the search result transmitting unit 33. The search result transmitting unit 33 transmits the search result sent out from the search processing unit 32 to the inquiry source which has sent out the search request message.

Next, an actual example of the searching processing will be explained. When the playback terminal 16 sends out a search request, in the recorder 13, the search request receiving unit 31 receives the search request message from the playback terminal 16. The search request receiving unit 31 extracts a search condition from the search request message, and delivers the search condition to the search processing unit 32. When the search condition is associated with video data, the search processing unit 32 makes an inquiry about whether or not video data which satisfy the search condition are recorded to the time reference data recording and deleting unit 22, whereas when the search condition is associated with log data, the search processing unit 32 makes an inquiry about whether or not log data which satisfy the search condition are recorded to the number reference data recording and deleting unit 25. The search processing unit 32 then sends the search result acquired with this inquiry back to the playback terminal 16 by way of the search result transmitting unit 33. Because a link search for the video data and the log data is carried out while a correspondence between the video data and the log data is established with a time, the search processing unit does not need to refer to the link table.

Thus, in accordance with this embodiment, because video data and log data are deleted synchronously and the link table 28 is then updated according to this deletion, a link searching process of searching for either video data or link data on the basis of the other one of them does not end in failure resulting from that there are no data which are the link destination. Furthermore, because the metadata management apparatus can detect that the log data are deleted, the metadata management apparatus can prevent the video data which are the link destination from continuing occupying a recording area vainly as event-triggered recorded video data even though the log data have been deleted. In the above-mentioned explanation, video data for monitoring are defined as time reference data. As an alternative, any other data can be defined as time reference data as long as the other data are managed with reference to time. Furthermore, number reference data are not limited to log data outputted from the sensors (the pieces of measurement equipment) 12 or the like, and any other data can be defined as number reference data as long as the other data are managed with reference to number. In addition, the input of log data into the recorder 13 is carried out via the network 15, as mentioned above. As an alternative, any other means can be used without strong constraints as long as the other means makes it possible to input a signal to the recorder.

As mentioned above, the metadata management apparatus in accordance with Embodiment 1 includes the time reference data recording and deleting unit for receiving time reference data which are managed with respect to time and recording the time reference data into the ring buffer for time reference data, and for deleting the time reference data from the ring buffer for time reference data; the number reference data recording and deleting unit for receiving number reference data which are managed with reference to number and recording the number reference data into the ring buffer for number reference data, and for deleting the number reference data from the ring buffer for number reference data; the link table for storing a link relation between the time reference data and the number reference data; and the link data management unit for updating the link table according to a recording state of the ring buffer for time reference data and a recording state of the ring buffer for number reference data, in which, when the number reference data are recorded into the ring buffer for number reference data, the link data management unit adds the link relation between the number reference data and the time reference data to the link table, and, when the time reference data are deleted from the ring buffer for time reference data or when the number reference data are deleted from the ring buffer for number reference data, instructs either the time reference data recording and deleting unit or the number reference data recording and deleting unit to also delete the data which are the link destination of the data which are deleted with reference to the link table, and then deletes the link relation from the link table. Therefore, the metadata management apparatus in accordance with this embodiment can synchronize the time reference data and the number reference data and can also prevent any mismatching from occurring in a link and useless event-triggered video images from being left even in a recorder used for monitoring which performs endless recording.

### Embodiment 2

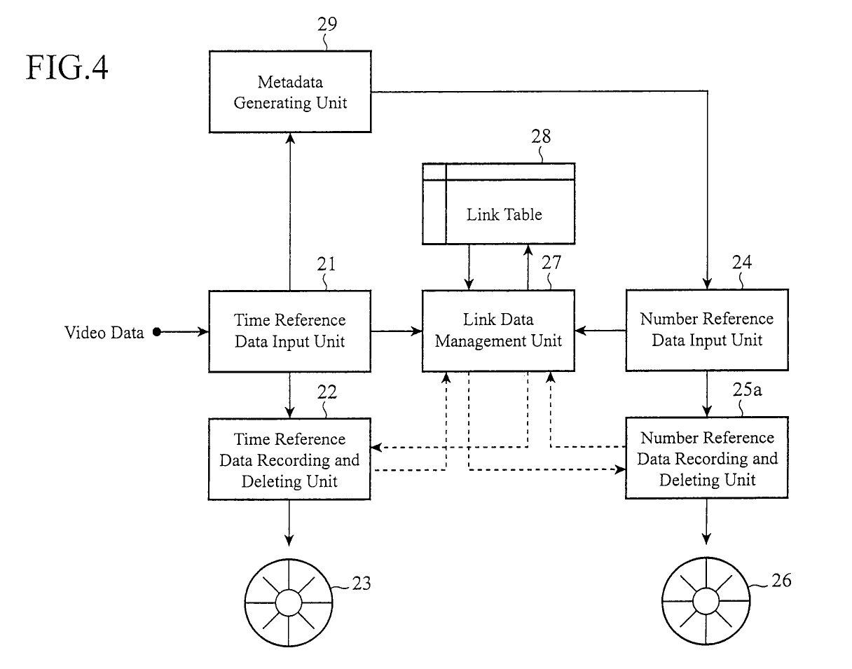

FIG. 4 is a block diagram of a metadata management apparatus in accordance with Embodiment 2 of the present invention. The metadata management apparatus in accordance with Embodiment 2 differs from that in accordance with Embodiment 1 in that a number reference data recording and deleting unit 25a is constructed in such a way as to, when overwriting old log data stored in a log recording ring buffer 26 with new log data, overwrite old log data starting from the one having the oldest recording time on the basis of the chronological order in which the log data currently stored were recorded into the log recording ring buffer 26. The metadata management apparatus in accordance with Embodiment 2 is further provided with a metadata generating unit 29 as a means for generating number reference data. This metadata generating unit 29 is constructed in such a way as to extract an object which is managed, as metadata (feature data), with reference to number from the video data through image processing, and to send, as number reference data, information about this object to a number reference data input unit 24. Because the other components of this Embodiment 2 are the same as those of Embodiment 1 shown in FIG. 2, the explanation of the other components will be omitted hereafter.

Next, the operation of the metadata management apparatus in accordance with Embodiment 2 will be explained. The video data inputted to the time reference data input unit 21 are delivered to the metadata generating unit 29, and the metadata generating unit 29 performs image processing on the received image data about one or more images to create metadata. The metadata acquired through the image processing can be either data about feature quantities included in each image frame or data about a person object which appears in a plurality of successive image frames. A person object which appears in a plurality of successive image frames is obtained by successively tracking a person who appears in the video from a time when the person appears for the first time to a time when the person disappears from the video, and then regarding this person as one person object. The metadata generating unit 29 creates one metadata from one person object. Each metadata includes an ID, an action, clothes, and soon for a corresponding person. In this case, because each person object is managed not with reference to time, but with reference to an ID (usually, the number of IDs is limited), and each metadata are managed with reference to number. Therefore, when metadata generated by the metadata generating unit 29 are inputted to the number reference data input unit 24, the subsequent fundamental processing which is carried out by the metadata management apparatus in accordance with Embodiment 2 is the same as that of Embodiment 1.

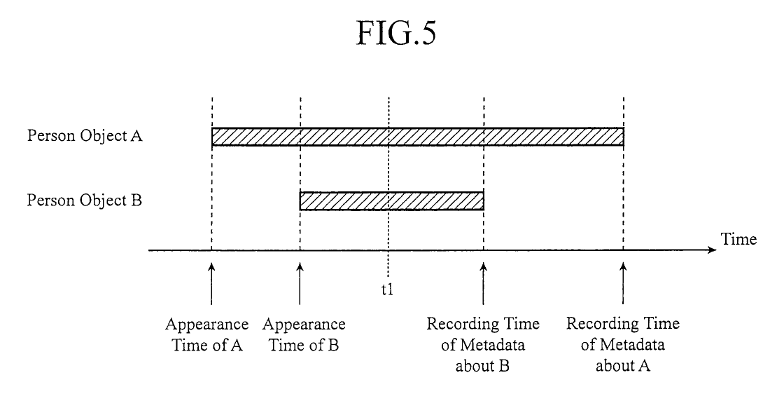

By the way, when a person object which appears in a plurality of successive image frames is obtained as metadata in this way, the metadata are not determined until the person object disappears from the video. Therefore, in a case in which metadata are not recorded into the buffer until they are determined, the chronological order in which person objects appear in the video is not necessarily equivalent to the chronological order in which corresponding metadata are recorded into the buffer. In an example as shown in FIG. 5, the chronological order in which metadata are recorded into the buffer is reverse to the chronological order in which corresponding person objects appear in the video. In such a case, in order to, for example, store a metadata history of only 1,000 most recent entries, there can be considered the two following methods: a method of leaving only 1,000 most recent entries in the chronological order that they appeared in the video, and a method of leaving only 1,000 most recent entries in the chronological order that they were recorded into the buffer. However, in the case of using the method of leaving only 1,000 most recent entries in the chronological order that they appeared in the video, in the example shown in FIG. 5, the metadata corresponding to the person object A are deleted previously. As a result, there can be a situation in which even though video data including the one about a scene in which the person object A appears remain (partially), there are no metadata about the person object A. For example, when the playback terminal tries to acquire the metadata about the person objects A and B at a time t1 of FIG. 5 when the person objects A and B appear simultaneously, the playback terminal can acquire the metadata about the person object B, but cannot acquire the metadata about the person object A, so that the user who is using the playback terminal judges that the link search has ended in failure. Therefore, in order to deal with a case in which such a reverse can take place, the number reference data recording and deleting unit 25a in accordance with Embodiment 2 overwrites and deletes old metadata in the chronological order in which the old metadata were recorded.

Thus, even when the chronological order in which metadata are recorded into the buffer is reverse to the chronological order in which corresponding person objects appear in the video, the number reference data recording and deleting unit in accordance with this Embodiment 2 overwrites and deletes old metadata in the chronological order in which the old metadata were recorded. Therefore, the number reference data recording and deleting unit can delete old metadata without deleting any metadata which are the link destination of existing video data.

In the above-mentioned example, an object which is extracted by the metadata generating unit 29 is defined as number reference data. Number reference data are not limited to such an object, and any other data can be similarly defined as number reference data as long as the other data are managed with reference to number. Furthermore, like in the case of Embodiment 1, any data can be defined as time reference data as long as the data are managed with reference to time.

As mentioned above, in each of the embodiments, the two ring buffers: the video recording ring buffer 23 and the log recording ring buffer 26 are disposed. However, in accordance with the present invention, the video recording ring buffer 23 and the log recording ring buffer 26 are not necessarily two physical ring buffers disposed separately, and can be implemented in such a way as to share only one ring buffer logically.

As mentioned above, when deleting number reference data from the ring buffer for number reference data, the number reference data recording and deleting unit of the metadata management apparatus in accordance with Embodiment 2 selects the number reference data to be deleted from number reference data already recorded in the ring buffer for number reference data on the basis of the chronological order in which the number reference data were recorded into the ring buffer for number reference data. Therefore, even in a case in which there are a plurality of number reference data, and, for example, the chronological order in which the plurality of number reference data are created is reverse to the chronological order in which the plurality of number reference data are recorded into the ring buffer, the number reference data recording and deleting unit can delete number reference data without deleting any number reference data which are the link destination of existing time reference data. Therefore, the metadata management apparatus can always maintain consistency of the link relation between time reference data and number reference data.

Many widely different embodiments of the present invention may be constructed without departing from the spirit and scope of the present invention. It should be understood that the present invention is not limited to the specific embodiments described in the specification, except as defined in the appended claims.

What is claimed is:

1. A metadata management apparatus, wherein said metadata management apparatus comprises:
a time reference data recording and deleting unit for receiving time reference data which are managed with respect to time and recording said time reference data into a ring buffer for time reference data, and for deleting said time reference data from said ring buffer for time reference data;
a number reference data recording and deleting unit for receiving number reference data which are managed with reference to number and recording said number reference data into a ring buffer for number reference data, and for deleting said number reference data from said ring buffer for number reference data;
a link table for storing a link relation between said time reference data and said number reference data; and
a link data management unit for updating said link table according to a recording state of said ring buffer for time reference data and a recording state of said ring buffer for number reference data,
and wherein, when said number reference data are recorded into said ring buffer for number reference data, said link data management unit adds the link relation between said number reference data and said time reference data to said link table, and, when said time reference data are deleted from said ring buffer for time reference data or when said number reference data are deleted from said ring buffer for number reference data, instructs either said time reference data recording and deleting unit or said number reference data recording and deleting unit to also delete the data which are a link destination of said data which are deleted with reference to said link table, and then deletes said link relation from said link table.

2. The metadata management apparatus according to claim 1, wherein when deleting number reference data from said ring buffer for number reference data, said number reference data recording and deleting unit selects the number reference data to be deleted from number reference data already recorded in said ring buffer for number reference data on a basis of an order in which said number reference data were recorded into said ring buffer for number reference data.
